(19) United States
(12) Patent Application Publication
(10) Pub. No.: US 2002/0194516 A1
(43) Pub. Date: Dec. 19, 2002

(54) Apparatus for setting output power levels of integrated PWM controller

(76) Inventors: Volodymyr A. Muratov, Durham, NC (US); Robert G. Hodgins, Durham, NC (US)

Correspondence Address: Thomas R. FitzGerald, Esq., JAECKLE FLEISCHMANN & MUGEL, LLP, 39 State Street, Rochester, NY, 14614-1310, US

(21) Appl. No.: 09/950,469

(22) Filed: Sep. 10, 2001

Related U.S. Application Data
(60) Provisional application No. 60/297,930, filed on Jun. 13, 2001.

(51) Int. Cl. G06F 1/26

(52) U.S. Cl. 713/320

(57) ABSTRACT

An electronic system 100 controls power to its central processing unit 22 with digital voltage identification (VID) codes and analog set signals. The VID codes are converted into an analog VID signal by digital to analog converter 42. An analog set voltage 62 generated by a sense network 60 sets the voltage level when the CPU operates at any voltage less than its maximum. Comparator 50 and switch 52 select either the analog VID voltage or the analog set voltage.

### CROSS-REFERENCE TO RELATED APPLICATIONS

This application claims the benefit of U.S. Provisional Patent Application Serial No. 60/297,930, filed Jun. 13, 2001 (Attorney Docket No. 87552.055001).

### FIELD OF INVENTION

Portable electronic devices, including laptop computers, cell phones and web pads are driven by central processing units (CPU) that require a power supply. Because portable devices run on batteries, power conservation is very important. In order to conserve power, manufacturers of portable devices often program the devices to have one or more power-saving modes of operation. For example, a typical cell phone, laptop or web pad may have a start mode, a sleep mode, as well as one or more intermediate power-saving modes. In a typical case, if the electronic device is not used for more than a certain amount of time, the CPU will signal to the device to go into a sleep or power-down mode.

With reference to FIG. 1, there is shown a typical system 10 with a CPU 20 that generates one or more power control level signals. The power output voltage for the CPU is provided by a DC/DC converter 40. CPU 20 is programmed to output one or more voltage identification codes (VID). In order to apply a proper voltage at startup, when the processor is unpowered, a multiplexer 30 is placed between the interface 22 of the CPU 20 and the power supply 40. When CPU 20 is inactive, multiplexer 30 receives VID codes from hard wired circuits, such as start mode circuit 24 and sleep mode circuit 26. The digital output signals from the multiplexer 30 are coupled to a digital-to-analog converter (DAC) 42. The DAC 42 receives a multibit signal that represents the desired power level. DAC 42 converts the digital power level signal into an analog signal, typically an analog voltage, and applies it to an error amplifier 44. The error amplifier 44 is part of a feedback control loop for the integrated pulse width modulated DC/DC 40 converter that includes the power circuit 46. One input of amplifier 44 receives the output of the power circuit 46 and the other input receives the desired power level from DAC 42. The amplifier 44 generates an output signal that drives the power circuit 46 to the desired power level.

Such prior art systems require a multiplexer 30 and also they require one or more hard wired complex multibit VID code generating circuits 24, 26 to generate digital signals for the power-saving modes. These VID codes include five bits or more. As a result, the size of the multiplexer is increased and the number of ancillary VID code circuits are increased. Such increases have an adverse impact upon the size and cost of the portable devices such as cell phones, personal digital assistants, and web pads as well as upon laptop computers.

### SUMMARY

The invention can reduce the number of elements in a portable system as well as its overall size. The invention can eliminate the multiplexer in small, handheld, portable electronic devices. The invention provides a power management system for a CPU. The system includes a power supply that generates a power output voltage and a power output current to operate the CPU at one or more levels of power operation. A feedback loop controls the DC/DC converter that generates the power supply for the system The feedback loop has one input coupled to the output of the power supply and a control input for receiving an analog signal that represents the desired power level. The control input to the feedback loop is coupled to a switch that toggles between first and second inputs. One input it connected to a sense network and the other input is connected to the conventional DAC output. The sense network includes a comparator with a reference input connected to the highest output of the DAC. Its other input is connected to a current source and a plurality of parallel connected sense circuits. Each sense circuit includes a series resistor and a transistor. The resistor in each series circuit has a different value that represents one of the power-saving modes. The transistor in each sense circuit is connected to one or more of the mode status outputs of the CPU. The transistor has a control electrode, typically its gate, which senses whether or not the CPU is in a power-saving mode. When the CPU enters a power-saving mode, one of the transistors in the sense circuits is turned on. This draws current from the current source, thereby altering the inputs to the comparator. The comparator then operates the switch to the control signal representative of the lower power level. As such, the invention replaces the multiplexer with a number of smaller sense circuits. Each sense circuit generates an analog voltage representative of a desired power level.

### DESCRIPTION OF THE DRAWINGS

FIG. 1 represents a prior art system showing a CPU core and a DC/DC converter;

FIG. 2 is a schematic representation of the invention connected to a CPU core;

FIG. 3 is a more detailed schematic representation of the invention.

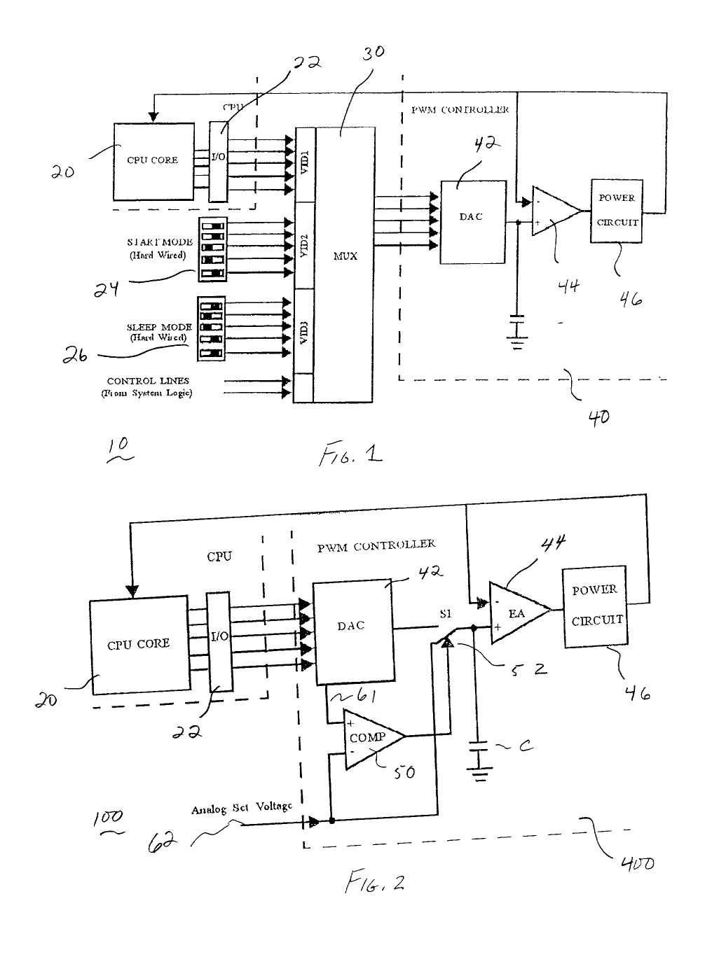

### DETAILED DESCRIPTION

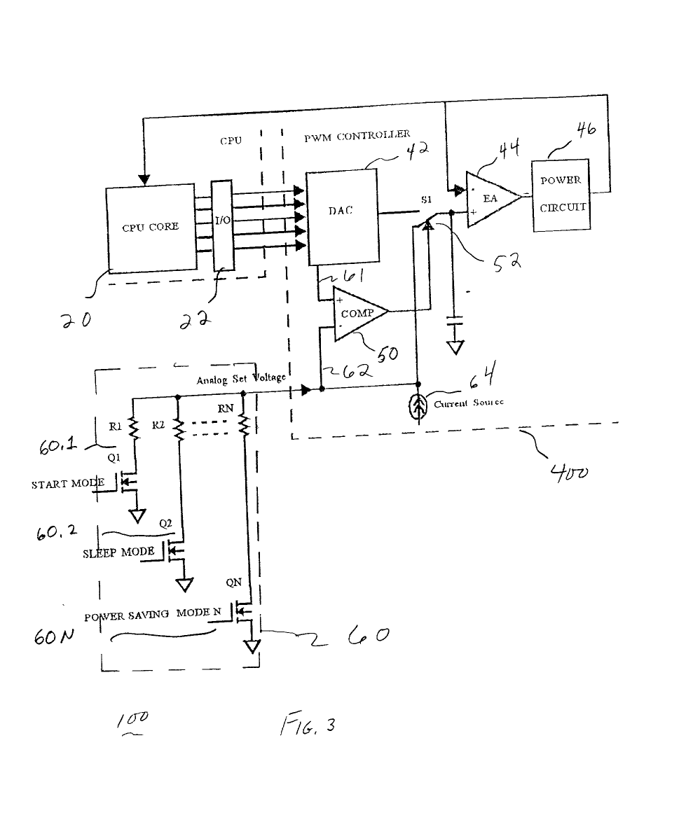

With reference to FIG. 2, where like reference numerals in other figures refer to the same elements, the multiplexer 30 is eliminated from the system 100. The power management system 100 is simplified by connecting the CPU core 20 through its 10 interface 22 to the digital-to-analog converter (DAC) 42. The DC/DC converter 400 includes an error amplifier 44 and power circuit 46. An output signal from the DAC 42 is connected to one input of comparator 50. An analog set voltage signal 62 is connected to the other input. The output of comparator 50 is coupled to and controls operation of switch 52. Switch 52 is represented as a schematic switch, but those skilled in the art would understand that it may comprise one or more transistors and other active or passive components. The switch 52 selects the analog voltage signal that is connected to the control input of the error amplifier 44. It selects either the analog VID output signal from DAC 42 or the analog set signal from the sense network 60.

In the preferred mode of operation, the input 61 that the comparator 50 receives from the DAC 42 is its highest power output level signal. The other input to comparator 50 is an analog set voltage 62. The analog set voltage 62 can be set at any one of a number of analog levels, and each settings is less than the highest DAC voltage 61. The analog set voltage 62 is generated by the sense network 60. The comparator 50 senses any difference between its two inputs 61, 62. It operates the switch 52 and couples the switch 52 to the analog set voltage 62 or to the DAC output 42. Under full power conditions, there is no difference between the inputs of comparator 50 and switch 52 operates to connect the DAC 42 to the error amplifier 44. When a reduced power mode is selected, the analog set voltage 62 is reduced. Comparator 50 senses the difference in voltage between its inputs and operates switch 51 to connect the analog set voltage 62 to the error amplifier 44.

In the preferred embodiment, as shown in FIG. 3, a sense network 60 includes a current source 64 and a plurality of series sense circuits comprising resistors and transistors. A typical series sense circuit, circuit 60.1, includes resistor R1 and transistor Q1 and corresponds to the start mode select operation. A sleep mode select circuit 60.2 includes resistor R2 and transistor Q2. Other power-saving circuits 60.N have a resistor RN and a transistor QN. When CPU 20 selects a mode other than its highest power operating level, one of the transistors Q1-QN is turned on. When one of transistors Q1-QN is on, the lower input to the comparator 50 is changed and the comparator operates the switch 52 to connect the switch 52 to the current source 64.

The analog set voltage 62 is created by the current source 64 and a series circuit 60.1-60.N. The resistor values R1, R2 . . . RN are chosen to gauge, in conjunction with the current source 64, a voltage drop that is equal to the desired core voltage for the selected mode of operation. The current source 64 attempts to raise the voltage on the analog set input 62 to the level of the power supply which is much higher than the highest preferred core voltage 61. This keeps the switch 52 in position such that the output of the DAC 42 programs the core voltage. However, when one of the transistors Q1, Q2 or QN is activated by its respective power reduction input signal, the analog set voltage 62 reduces to a level that is lower than the highest core preferred voltage 61. This reduction is sensed by the comparator 50 that constantly monitors the analog set voltage 62 and compares it to the maximum preferred core voltage generated by the DAC 42.

As stated above, the system is initially configured so that the current of source input 64 to the comparator is always greater than the DAC input 61. Under normal operation DAC output 61 is the highest desired output power and the switch 52 connects DAC 42 to error amplifier 44. However, when the core CPU 20 enters a power-saving mode of operation, one of the transistors Q1, Q2, or QN turns on. When this occurs, the voltage at the negative input of the comparator 50 drops below the highest output DAC voltage 61 attached to the positive input of the comparator 50. The output of the comparator 50 operates to throw the switch 52, disconnect the DAC 42 from the error amplifier 46, and connect the error amplifier 46 to the output of the current source 62.

Having thus described the preferred embodiment of the invention, those skilled in the art will appreciate that further modifications, additions and deletions are possible to the individual components described above without departing from the spirit and scope of the invention as set forth in the appended claims.

1. A method for supplying power to a central processing unit comprising:
generating voltage identification digital (VID) codes within a range of preferred core voltages;
receiving the VID codes;
converting the VID codes into analog VID voltage signals representing the VID codes;
generating the output power in accordance with the analog VID voltage signals representing the VID codes;
sensing analog set signals representative of desired output power voltage;
setting the output power in accordance with the analog set signals when the analog set signals are within the range of preferred core voltages.

2. The method of claim 1 further comprising comparing a reference core analog VID voltage signal to the analog set voltage signals.

3. The method of claim 1 further comprising the step of pulse width modulating an oscillating power signal in accordance with either the analog VID voltage signal or the analog set voltage signal to generate an output power voltage.

4. A pulse width modulated (PWM) controller for a supplying power to a central processing unit (CPU) comprising:
means for receiving voltage identification digital (VID) codes from a CPU within a range of preferred core voltages;
means for converting the VID codes into analog voltage VID signals representing the VID code;
means for sensing analog set signals representative of desired output power voltage, and
means for setting the output power of the PWM controller in accordance with the analog VID voltage signals and for setting the output power in accordance with the analog set signals when the analog set signals are within the range of preferred core voltages.

5. The PWM controller of claim 4 further comprising means for comparing the analog VID voltage signals to the analog set voltage signals.

6. The PWM controller of claim 4 further comprising a switch connected to the sensing means for switching the PWC controller to set the output power in accordance with the analog VID voltage signals or the analog set voltage signals.

7. The PWM controller of claim 6 wherein the switch connects the analog set voltage signals to the input of the PWM controller when the analog set voltage signals are within the range of the analog VID voltage signals and connects the analog VID voltage signals to the PWM when the analog set voltage signals are outside the range of the analog VIDvoltage signals.

8. The power supply of claim 4 further comprising a digital-to-analog converter (DAC) for converting voltage identification codes of a CPU into analog VID control signals.

9. The power supply of claim 4 wherein the means for sensing the analog set signals comprises a comparator and a sense network.

10. The power supply of claim 9 wherein the sense network comprises a current source and a plurality of series circuits, each series circuit altering the output of the current source when the CPU operates at less than its highest operating power level.

11. The power supply of claim 10 wherein each series circuit comprises a resistor and transistor and the resistors are set at different sizes to correspond to different power operating levels.

12. A power management system for a computer comprising:
a power supply for generating a power output voltage and power output current to operate a central processing unit at one or more levels of power operation;
said power supply having two or more power level command inputs and a switch for selecting one of the power command inputs;
a first input for receiving an analog VID signal representative of desired power level commanded by a processor powered by the power supply;
a second input for receiving an analog set signal of desired power level representative of the operating mode of the processor;
a sense circuit for sensing the presence of the second input and for operating the power supply in accordance one of the two analog power signals.

13. The power management system of claim 12 further comprising a switch coupled to the sense circuit for selecting the first input when the second input is in one range of voltages and for selecting the second input when the second input is outside said range of voltages.

14. The power management system of claim 12 further comprising a feedback loop coupled between the power output and the input to the power supply.

15. A power management system for a computer comprising:
a power supply for generating a power output voltage and power output current to operate a central processing unit at one or more levels of power operation;
a feedback loop coupled between the input and the output of the power supply for setting the level of the power output;
a switch coupled to the feedback loop and operable to connect one of two power level signals to the feedback control input of the feedback loop;
a converter network for converting digital signals into analog VID power level signals representative of a power level commanded by a processor;
a network for generating analog set signals representative of a power level in accordance with the operating mode of a processor;
a sense circuit for sensing the two analog signals and selecting one of the two analog signals for setting the level of the power output.

16. The power management system of claim 15 further comprising the central processing unit (CPU) and a digital-to-analog converter (DAC) wherein the CPU generates a digital VID signal representative of power level commanded by the CPU and the DAC converts the digital power command signals into the analog VID signals.

17. The power management system of claim 15 wherein the sense network comprises a current source and one or more series circuits each having a resistor and a transistor, wherein operation of one of the transistors alters the output of the current source.

18. The power management system of claim 17 wherein each series circuit corresponds to a power mode of operation selected from the group consisting of start mode, sleep mode and power-saving mode.

19. The power management system of claim 15 wherein the sense network further comprises a comparator for comparing analog VID and set signals and for selecting one of the two signals in accordance with a threshold level.

20. The power management system of claim 19 wherein the comparator selects the analog VID signal when the analog set signal is in a first range and selects the analog set signal when the analog set signal is out of said first range.

21. The power management system of claim 15 wherein the power supply comprises a pulse width modulated dc-to-dc converter with a power output bridge comprising two or more power mosfets.
